(19) United States
(12) Patent Application Publication
(10) Pub. No.: US 2008/0082943 A1
(43) Pub. Date: Apr. 3, 2008

(54) Terminal and display method for the same

(75) Inventors: Stanley Chung, Seoul (KR); Jung-hyun Shim, Seongnam-si (KR); Chang-su Kim, Suwon-si (KR); Ju-hwan Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/892,528

(22) Filed: Aug. 23, 2007

(30) Foreign Application Priority Data
Oct. 2, 2006 (KR) 10-2006-0097444
Apr. 16, 2007 (KR) 10-2007-0037162

(51) Int. Cl. G06F 3/048

(52) U.S. Cl. 715/835

(57) ABSTRACT

A terminal and a display method for the same are provided. In the terminal and the display method for the same, a first image is displayed on the main display unit. One or more second images matched with the first image are displayed on a plurality of buttons. Accordingly, it is possible to maximize manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

### CROSS-REFERENCE TO RELATED PATENT APPLICATION

This application claims the benefit of Korean Patent Application Nos. 10-2006-0097444, filed on Oct. 2, 2006 and 10-2007-0037162, filed on Apr. 16, 2007, in the Korean Intellectual Property Office, the disclosure of which is incorporated herein in its entirety by reference.

### BACKGROUND OF THE INVENTION

1. Field of the Invention

The present invention relates to a terminal, and more particularly, to a terminal including buttons that are input units and a screen having a display function.

2. Description of the Related Art

In general, a terminal includes a plurality of buttons that are input units and a screen having a display function. An example of the terminal is a mobile phone.

A user, who desires to manipulate the buttons of the terminal, has to complicatedly manipulate the buttons, since the user has to determine which button to be pressed by watching the screen. As the number of functions of the terminal increases and as the user is less skillful at manipulation of the terminal for using the functions, this complicatedness becomes serious.

Accordingly, there is required a method capable of maximizing manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

### SUMMARY OF THE INVENTION

The present invention provides a terminal capable of maximizing manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

The present invention also provides a display method capable of maximizing manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

The present invention also provides a computer-readable recording medium having embodied thereon a computer program capable of maximizing manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

According to an aspect of the present invention, there is provided a terminal comprising: a main display unit displaying a first image; and a plurality of buttons displaying one or more second images matched with the first image.

According to another aspect of the present invention, there is provided a display method to be performed in a terminal including a main display unit and a plurality of buttons, the display method comprising: displaying a first image on the main display unit; and displaying one or more second images matched with the first image on the plurality of buttons.

According to another aspect of the present invention, there is provided a computer-readable recording medium having embodied thereon a computer program to be executed in a terminal including a main display unit and a plurality of buttons, the computer program for executing a method comprising: displaying a first image on the main display unit; and displaying one or more second images matched with the first image on the plurality of buttons.

The attached drawings for illustrating exemplary embodiments of the present invention are referred to in order to gain a sufficient understanding of the present invention, the merits thereof and the objectives accomplished by the implementation of the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a terminal according to an embodiment of the present invention;

FIGS. 2A and 2B illustrate examples of an external appearance of a terminal according to an embodiment of the present invention;

FIGS. 3, 4, 5A-5C, 6, and 7 are reference views illustrating a terminal according to an embodiment of the present invention; and

FIG. 8 is a flowchart illustrating a display method according to an embodiment of the present invention.

### DETAILED DESCRIPTION OF THE INVENTION

Hereinafter, a terminal and a method of displaying the same according to an embodiment of the present invention will be described with reference to the attached drawings.

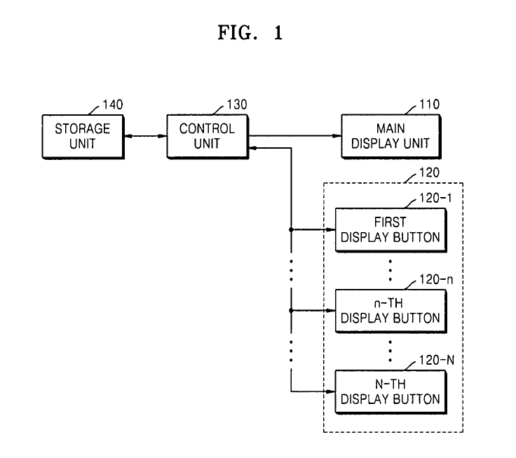

FIG. 1 is a block diagram illustrating a terminal according to an embodiment of the present invention. The terminal may include a main display unit 110, a plurality of buttons 120, a control unit 130, and a storage unit 140.

The main display unit 110 displays a first image in response to a control signal. The plurality of buttons 120 display one or more second images matched with the first image in response to the control signal. In the invention, the first image indicates an image displayed on the main display unit 110. The second images indicate images displayed on the buttons. The correspondence between first images and second images may be previously determined.

Accordingly, when the first image displayed on the main display unit 110 is updated, the one or more second images displayed on the plurality of buttons 120 are updated into one or more second images matched with the updated first image. More specifically, when the first image displayed on the main display unit 110 is updated, the plurality of buttons 120 display one or more second images which are previously designated so as to be selected by a user who recognizes the updated first image.

On the other hand, the plurality of buttons 120 may include one or more non-displayable buttons (not shown) in addition to N number of display buttons 120-1 to 120-N (N is an integer). Here, a display button 120-n (n and N are integers which satisfy 1≦n≦N) indicates a button having a display function. A non-display button (not shown) indicates a button having no display function. The N number of display buttons 120-1 to 120-N displays N number of second images at most.

A screen of the main display unit 110 indicates a main screen. Screens of the display buttons 120-n indicates sub-screens. The N number of display buttons 120-1 to 120-N may be embodied as a screen that is divided into N areas.

The control unit 130 generates a control signal in response to a manipulation result of the buttons. Here, the buttons may be the display buttons 120-n or non-display buttons (not shown). Specifically, the control signal is used to instruct a first image corresponding to the manipulation result of buttons among previously prepared first images to be displayed on the main display unit 110 and instruct second images corresponding to the manipulation result of buttons among previously prepared second images to be displayed on the display buttons 120-n. More specifically, a k-th generated control signal is determined by considering (k-1)-th displayed first and second images and k-th manipulation result of the buttons 120.

The aforementioned previously prepared first and second images are stored in the storage unit 140. The storage unit 140 may be included in or separated from the terminal according to the embodiment. On the contrary, the main display unit 110, the buttons 120, and the control unit 130 may be included in the terminal according to the embodiment.

Finally, the control unit 130 reads the first image corresponding to the manipulation result of the buttons among the first images stored in the storage unit 140 and instructs the main display unit 110 to display the read first image. Similarly, the control unit 130 reads the second images corresponding to the manipulation result of the buttons among the second images stored in the storage unit 140 and instructs the plurality of buttons 120 to display the read second images.

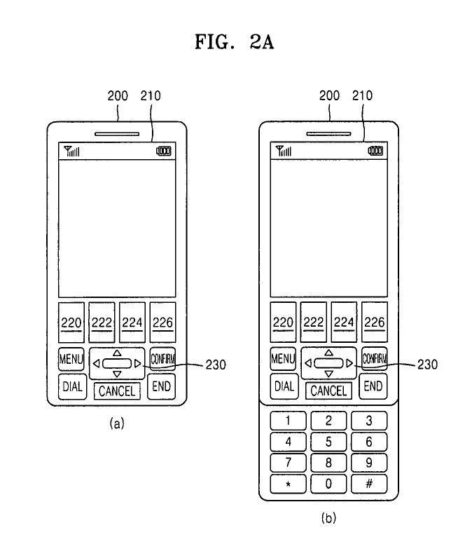

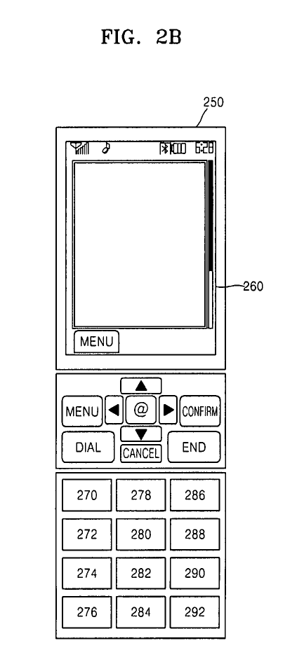

FIGS. 2a and 2b illustrate examples of an external appearance of a terminal according to an embodiment of the present invention.

Specifically, (a) of FIG. 2a illustrates an external appearance of a sliding-type terminal 200 in a closed condition of a sliding housing into a main housing. (b) of FIG. 2a illustrates an external appearance of a sliding-type terminal 200 in an opened condition of the sliding housing from the main housing.

As shown in FIG. 2a, the sliding-type terminal 200 includes sliding and main housings. The sliding housing include a main display unit 210, four display buttons 220 to 226, and a plurality of non-displayable buttons (a menu button, a direction key 230, a confirm button, a dial button, a cancel button, and an end button). The main housing includes a plurality of non-display buttons (number keys 0 to 9 and special function buttons * and #).

On the other hand, FIG. 2b illustrates an external appearance of a folder-type terminal 250 in an opened condition of a folder from a main housing.

As shown in FIG. 2b, the folder-type terminal 250 includes a main display unit 260, twelve display buttons 270 to 292, a plurality of non-display buttons (a menu button, direction keys ▴, ▾, [symbol] , and [symbol] , a confirm button, a dial button, a cancel button, and an end button).

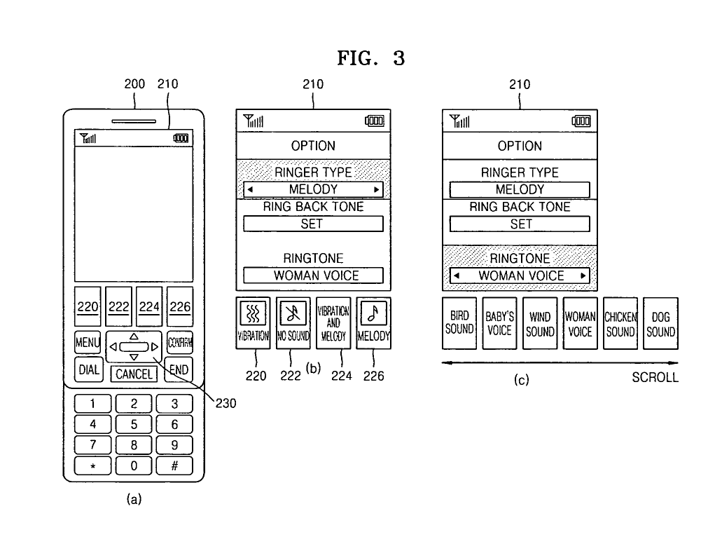

FIGS. 3 to 7 are reference views illustrating a terminal 200 or 250 according to an embodiment of the present invention.

The terminal 200 according to the embodiment of the present invention will be described with reference to FIG. 3.

As shown in FIG. 3, a user desires to set various options by using the terminal 200 shown in (a) of FIG. 3. Accordingly, as shown in (b) or (c) of FIG. 3, the main display unit 210 can display a window for setting options as a first image. In (b) or (c) of FIG. 3, the first image is the window including three items such as a ringer type, a ring back tone, and a ringtone. Here, the ringer type indicates an item for selecting a ringer type such as vibration, melody, vibration and melody, and no-sound modes for specifying how a user is to be informed of an incoming call of the terminal 200. The ring back tone indicates an item for setting whether a sound is generated after dialing by using the terminal 200 and prior to the call being answered at a receiving end. The ringtone indicates an item for selecting the ringtone for the call ringer of the terminal 200.

An item, which is selected among items of the first image shown in (b) and (c) of FIG. 3 based on a manipulation result of a button, is shaded. At this time, the button may be one of the display buttons 220 to 226 or one of the non-display buttons (the menu button, the direction key 230, the confirm button, the dial button, the cancel button, the end button, the number keys 0 to 9, and the special function buttons * and #). The item selected among the items represented on the first image shown in (b) of FIG. 3 is the ringer type. The item selected among the items represented on the first image shown in (c) of FIG. 3 is the ringtone. Accordingly, the first image shown in (b) of FIG. 3 is different from the first image shown in (c) of FIG. 3.

In (b) of FIG. 3, the display buttons 220 to 226 display four second images for representing vibration, melody, vibration and melody, and no-sound modes. Here, the vibration mode indicates a mode in which a user is informed of an incoming call through vibration. The no-sound mode indicates a mode in which a user is informed of an incoming call through no-sound and no-vibration. The vibrations and melody mode indicates a mode in which a user is informed of an incoming call through vibration and melody. The melody mode indicates a mode in which a user is informed of an incoming call through melody.

As shown (b) of FIG. 3, when the first image (the first image in which the item for indicating the ringer type is selected) is displayed, there are automatically displayed one or more second images for indicating one or more operations (operations for setting the ringer type to the vibration, no-sound, vibration and melody, and melody modes), which are instructed by the user who recognizes the displayed first image to be executed by the terminal, on the display buttons 220 to 226. Accordingly, the user who recognizes the first image needs not execute complicated button manipulations (for example, two manipulations of pressing the confirm button so as to enable the main display unit 210 to display ringer types by numbering the ringer types and pressing one of the number keys assigned to the ringer types so as to select a desired ringer type) by alternately watching the main display unit 210, the display buttons 220 to 226, and the plurality of non-displayable buttons. Thus, the user can instruct the terminal 200 to execute any operation by pressing or applying pressure on a button 220 on which a second image (for example, the vibration mode) for indicating a predetermined operation (an operation for setting the ringer type to the vibration mode) is displayed among the display buttons 220 to 226.

In (c) of FIG. 3, although the display buttons 220 to 226 desire to display six second images for representing bird sound, baby's voice, wind sound, woman voice, chicken sound, and dog sound modes, the number of the display buttons 220 to 226 included in the terminal 200 is four. The display buttons 220 to 226 display four second images among the six second images. In this case, the user can scrolls all the six second images by manipulating the direction key 230. On the other hand, the bird sound mode indicates a mode in which the ringtone of the terminal 200 is set to bird sound. The baby's voice mode indicates a mode in which the ringtone of the terminal 200 is set to baby's voice. The wind sound mode indicates a mode in which the ringtone of the terminal 200 is set to wind sound. The woman voice mode indicates a mode in which the ringtone of the terminal 200 is set to woman voice. The chicken sound mode indicates a mode in which the ringtone of the terminal 200 is set to chicken sound. The dog sound mode indicates a mode in which the ringtone of the terminal 200 is set to dog sound.

As shown in (c) of FIG. 3, when the first image (the first image in which the item for indicating the ringtone is selected) is displayed, there are automatically displayed second images for indicating operations (four operations among operations for setting the ringtone to the bird sound, baby's voice, wind sound, woman voice, chicken sound, and dog sound modes) which are instructed by the user who recognizes the displayed first image to be executed by the terminal, on the display buttons 220 to 226. Accordingly, the user who recognizes the first image needs not execute complicated button manipulations (for example, two manipulations of pressing the confirm button so as to enable the main display unit 210 to display ringtones by numbering the ringtones and pressing one of the number keys assigned to the ringtones so as to select a desired ringtone) by alternatively watching the main display unit 210, the display buttons 220 to 226, and the plurality of non-displayable buttons. Thus, the user can instruct the terminal 200 to execute any operation by pressing or applying pressure on a button 220 on which a second image (for example, the baby's voice) for indicating a predetermined operation (an operation for setting the ringtone to the baby's voice mode) is displayed among the display buttons 220 to 226.

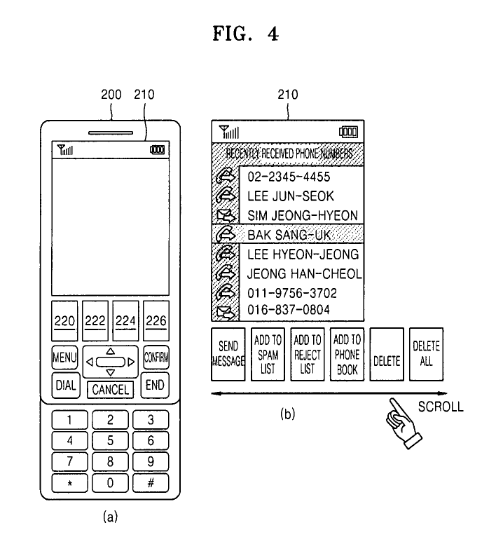

The terminal 200 according to the embodiment of the present invention will be described with reference to FIG. 4.

As shown in FIG. 4, a user desires to manage recently received phone numbers of the terminal 200 shown in (a) of FIG. 4. Accordingly, as shown in (b) of FIG. 4, the main display unit 210 can display a first image for representing the recently received phone numbers. A phone number (for example, a phone number of Bak Sang-Uk), which is selected among the phone numbers shown in (b) of FIG. 4 based on a manipulation result of a button, is shaded. At this time, the button may be one of the display buttons 220 to 226 or one of the non-display buttons (the menu button, the direction key 230, the confirm button, the dial button, the cancel button, the end button, the number keys 0 to 9, and the special function buttons * and #).

In (b) of FIG. 4, although the display buttons 220 to 226 desire to display six second images for representing items such as “send message”, “add to SPAM list”, “add to reject list”, “add to phonebook”, “delete”, and “delete all”, the number of the display buttons 220 to 226 included in the terminal 200 is four. The display buttons 220 to 226 display four second images among the six second images. In this case, the user can scrolls all the six second images by manipulating the direction key 230. On the other hand, the item for representing “send message” indicates an operation of sending a message to the selected phone number (the phone number of Bak Sang-Uk). The item for representing “add to SPAM list” indicates an operation of adding the selected phone number to a SPAM list of the terminal 200. The item for representing “add to reject list” indicates an operation of adding the selected phone number to a reject list of the terminal 200. The item for representing “add to phonebook” indicates an operation of adding the selected phone number to a phonebook of the terminal 200. The item for representing “delete” indicates an operation of deleting the selected phone number from a list of the recently received phone numbers. The item for representing “delete all” indicates an operation of deleting all the phone numbers included in the list of the recently received phone numbers.

As shown in (b) of FIG. 4, when the first image (the first image in which the phone number of Bak Sang-Uk is selected) is displayed, there are automatically displayed second images for indicating operations (four operations among operations of transmitting a message to the selected phone number, adding the selected phone number to the SPAM list, adding the selected phone number to the reject list, adding the selected phone number to the phonebook, deleting the selected phone number from the list of the recently received phone numbers, and deleting all the phone numbers included in the list of the recently received phone numbers) which are instructed by the user who recognizes the displayed first image to be executed by the terminal, on the display buttons 220 to 226. Accordingly, the user who recognizes the first image needs not execute complicated button manipulations (for example, two manipulations of pressing the confirm button so as to enable the main display unit 210 to display operations which are executed in relation to the selected phone number in the terminal 200 by numbering the operations and pressing one of the number keys assigned to the operations so as to select the operation desired to be executed) by alternatively watching the main display unit 210, the display buttons 220 to 226, and the plurality of non-display buttons. Thus, the user can instruct the terminal 200 to execute any operation by pressing or applying pressure on a button 220 on which a second image (for example, “add to phonebook”) for indicating a predetermined operation (an operation for adding the selected phone number to the phonebook) is displayed among the display buttons 220 to 226.

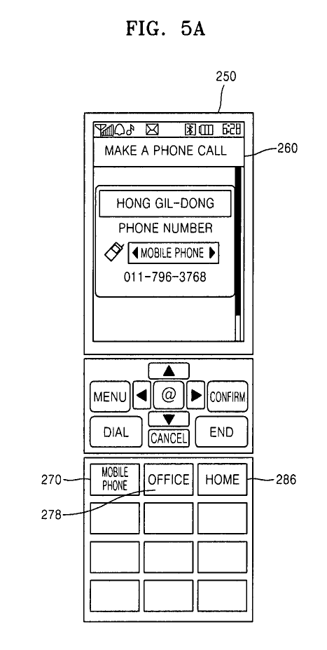

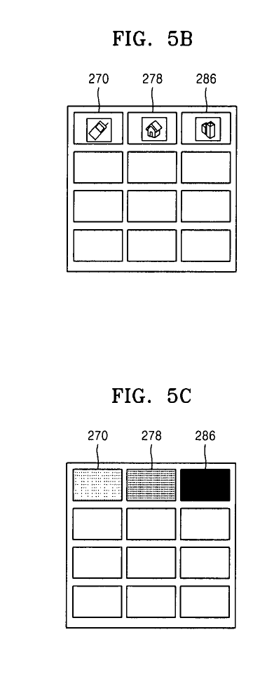

The terminal 250 according to the embodiment of the present invention will be described with reference to FIGS. 5a to 5c.

A user desires to make a phone call to somebody (for example, Hong Gil-Dong). Accordingly, as shown in FIG. 5a, the main display unit 210 can display a first image for representing a phone number of Hong Gil-Dong. At this time, the phone number displayed on the first image may be a mobile phone number, office phone number, or home phone number of Hong Gil-Dong. In this case, the phone number displayed on the first image may be changed by manipulating the direction keys ▴, ▾, □, and □.

In FIG. 5a, the display buttons 270, 278, and 286 display three second images for representing “Mobile Phone”, “Office”, and “Home”. Here, “Mobile Phone” indicates an image for making a phone call through the mobile phone number of the receiving end (for example, Hong Gil-Dong) displayed on the first image. “Office” indicates an image for making a phone call through the office phone number of the receiving end displayed on the first image. “Home” indicates an image for making a phone call through the home phone number of the receiving end displayed on the first image.

As shown in FIG. 5a, the display buttons 270, 278, and 286 may display the desired second images as text. As shown in FIG. 5b, the display buttons 270, 278, and 286 may display the desired second images as images. As shown in FIG. 5c, the display buttons 270, 278, and 286 may display the desired second images as colors. As shown in FIG. 5b, when the second images are displayed as images, the user may be previously aware of correspondences of the images to the types of the phone numbers. Similarly, as shown in FIG. 5c, when the second images are displayed as colors, the user may be previously aware of correspondences of the colors to the types of the phone number.

As shown in FIG. 5a, 5b, or 5c, when the first image (the first image in which the mobile phone number of Hong Gil-Dong is selected) is displayed, there are automatically displayed second images for operations (operations for making a phone call through the mobile phone number, the office phone number, and the home phone number of Hong Gil-Dong), which are instructed by the user who recognizes the displayed first image to be executed by the terminal, on the display buttons 270, 278, and 286. Accordingly, the user, who recognizes the first image and desires to make a phone call through the home phone number of Hong Gil-Dong, needs not execute complicated button manipulations (for example, three manipulations of pressing the direction key □ twice so as to display the home phone number of Hong Gil-Dong and pressing the confirm button) by alternately watching the main display unit 210, the display buttons 270 to 292, and the plurality of non-displayable buttons. Thus, the user can instruct the terminal 250 to execute any operation by pressing or applying pressure on a button 286 on which a second image (for example, “Home”) for indicating a predetermined operation (an operation for making a phone call through the home phone number of Hong Gil-Dong) is displayed among the display buttons 270, 278, and 286.

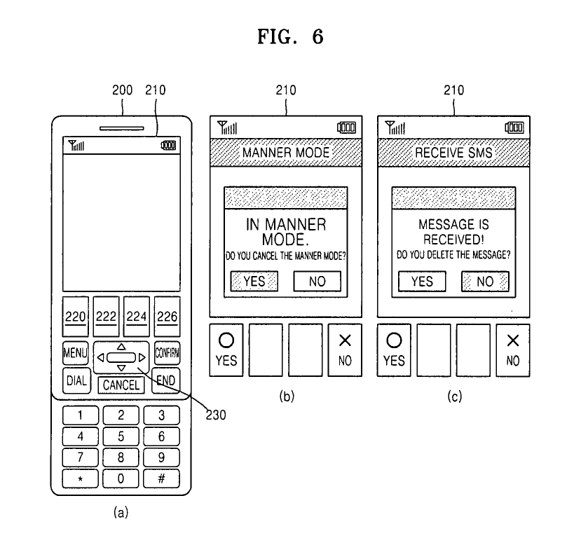

The terminal 200 according to the embodiment of the present invention will be described with reference to FIG. 6.

As shown in FIG. 6, the terminal 200 shown in (a) of FIG. 6 requests a user to select one of various items.

Specifically, as shown in (b) of FIG. 6, the user can instruct the terminal 200 in a manner mode to cancel the manner mode by manipulating the buttons, so that the terminal 200 may not operate in the manner mode. In this case, as shown in (b) of FIG. 6 the main display unit 210 displays a first image for confirming a user's intention. As shown in (b) of FIG. 6, the display buttons 220 and 226 display second images (“Yes O” and “No X”) for indicating options (“Yes” and “No”) represented on the first image. At this time, the options (“Yes O” and “No X”) displayed on the display buttons 220 and 226 are more largely displayed than those (“Yes” and “No”) displayed on the main display unit 210.

As shown in (b) of FIG. 6, when the first image (the first image in which it is asked whether the manner mode is canceled and in which the option for canceling the manner mode is activated) is displayed, there are automatically displayed second images for operations (operations for canceling and maintaining the manner mode), which are instructed by the user who recognizes the displayed first image to be executed by the terminal, on the display buttons 220 and 226. Accordingly, the user, who recognizes the first image and desires to maintain the manner mode, needs not execute complicated button manipulations (for example, two manipulations of pressing the direction key 230 so as to activate “No” on the first image and pressing the confirm button) by alternately watching the main display unit 210, the display buttons 220 to 226, and the plurality of non-displayable buttons. Thus, the user can instruct the terminal 200 to perform any operation by pressing or applying pressure on a button 226 on which a second image (for example, “No X”) for indicating a predetermined operation (an operation for maintaining the manner mode) is displayed among the display buttons 220 and 226.

On the other hand, as shown in (c) of FIG. 6, the user desires to delete a text message received by the terminal 200. In this case, as shown in (c) of FIG. 6, the main display unit 210 displays a first image for confirming the user's intention. As shown in (c) of FIG. 6, the display buttons 220 and 226 display second images (“Yes O” and “No X”) for indicating options (“Yes” and “No”) represented on the first image. At this time, the options (“Yes O” and “No X”) displayed on the display buttons 220 and 226 are more largely displayed than those (“Yes” and “No”) displayed on the main display unit 210.

As shown in (c) of FIG. 6, when the first image (the first image in which it is asked whether the text message is stored and in which the option for not storing the text message is activated) is displayed, there are automatically displayed second images for operations (operations for deleting and storing the text message), which are expected to be executed by the user who recognizes the displayed first image, on the display buttons 220 and 226. Accordingly, the user, who recognizes the first image and desires to delete the text message, needs not execute complicated button manipulations (for example, two manipulations of pressing the direction key 230 so as to activate “Yes” on the first image and pressing the confirm button) by alternately watching the main display unit 210, the display buttons 220 to 226, and the plurality of non-displayable buttons. Thus, the user can instruct the terminal 200 to execute any operation by pressing or applying pressure on a button 226 on which a second image (for example, “YES O”) for indicating a predetermined operation (an operation for deleting the text message) is displayed among the display buttons 220 and 226.

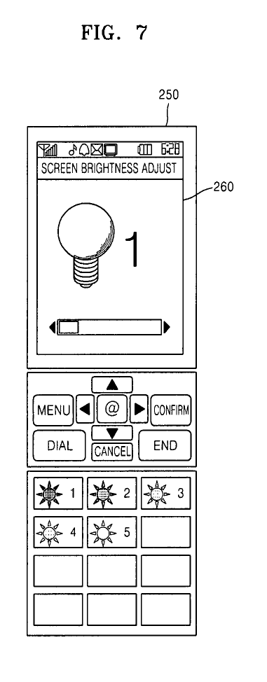

The terminal 250 according to the embodiment of the present invention will be described with reference to FIG. 7.

As shown in FIG. 6, the user desires to adjust brightness of the main display unit 260. The main display unit 260 displays a bulb image with variable brightness as a first image. The display buttons 270, 272, 278, 280, 286 display five second images for representing various brightness levels.

As shown in FIG. 7, when the first image (the first image in which a bulb image with brightness of a first level is displayed) is displayed, there are automatically displayed second images for operations (operations for setting the brightness to first to fifth levels), which are instructed by the user who recognizes the displayed first image to be executed by the terminal, on the display buttons 270, 272, 278, 280, and 286. Accordingly, the user, who recognizes the first image and desires to adjust the brightness of the main display unit 260 to the fourth level, needs not execute complicated button manipulations (for example, four manipulations of repeatedly pressing the direction key □ three times so as to display the bulb image with brightness of the fourth level and pressing the confirm button) by alternately watching the main display unit 260, the display buttons 270 to 292, and the plurality of non-displayable buttons. Thus, the user can instruct the terminal 250 to execute any operation by pressing or applying pressure on a button 272 on which a second image for indicating a predetermined operation (an operation for setting the brightness to the fourth level) is displayed among the display buttons 270, 272, 278, 280, and 286.

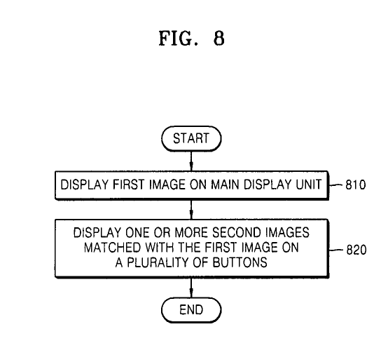

FIG. 8 is a flowchart illustrating a display method according to an embodiment of the present invention. The display method may include operations (operations 810 to 820), in which it is possible to maximize manipulation convenience of the user who manipulates buttons so as to instruct the terminal to perform any operation by minimizing the complicatedness of the manipulations of the buttons caused by alternately watching a screen and the buttons by enabling the user who uses the terminal including the plurality of buttons and the screen to perform the desired button manipulations through the minimized button manipulations.

The main display unit 110 displays a first image (operation 810).

In addition, the plurality of buttons 120 display one or more second images matched with the first image displayed in operation 810 (operation 820).

As shown in FIG. 8, operation 820 may be performed after operation 810. Unlike FIG. 8, operations 810 and 820 may be performed at the same time. Unlike FIG. 8, operation 820 may be performed before operation 810.

As described above, in the terminal and the display method for the same according to an embodiment of the present invention, a first image is displayed on the main display unit. One or more second images matched with the first image are displayed on a plurality of buttons. Accordingly, it is possible to maximize manipulation convenience of the user who manipulates buttons so as to instruct the terminal to perform any operation by minimizing the complicatedness of the manipulations of the buttons caused by alternately watching a screen and the buttons by enabling the user to perform the desired button manipulations through the minimized button manipulations.

Specifically, in the terminal and the display method for the same according to an embodiment of the present invention, when the first image is displayed on the main display unit, there are automatically displayed second images for representing operations instructed by the user who recognizes the displayed first image to be executed by the terminal, on the plurality of buttons. Accordingly, the user who recognizes the first image can instruct the terminal to perform any operations by pressing or applying pressure on a button on which a second image for indicating a predetermined operation is displayed among the displayed buttons without complicated button manipulations. Thus, it is possible to maximize the manipulation convenience of the user who manipulates buttons so as to instruct the terminal to perform any operation.

Computer programs for executing the aforementioned method of managing a memory according to an embodiment of the present invention can be written in a computer readable recording medium. Examples of the computer readable recording medium include magnetic storage media (e.g., ROM, floppy disks, hard disks, etc.) and optical recording media (e.g., CD-ROMs, or digital versatile discs (DVDs)).

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A terminal comprising:
a main display unit displaying a first image; and
a plurality of buttons displaying one or more second images matched with the first image.

2. The terminal of claim 1, wherein the second images are updated whenever the first image is updated.

3. The terminal of claim 1, wherein the plurality of buttons display the second images which are previously designated so as to be able to be selected by a user who recognizes the first image.

4. The terminal of claim 1, wherein the first image is updated in correspondence with the manipulation result of the buttons.

5. A display method to be performed in a terminal including a main display unit and a plurality of buttons, the display method comprising:
(a) displaying a first image on the main display unit; and
(b) displaying one or more second images matched with the first image on the plurality of buttons.

6. The display method of claim 5, wherein the second images are updated whenever the first image is updated.

7. The display method of claim 5, wherein in (b), the second images, which are previously designated so as to be able to be selected by a user who recognizes the first image, are displayed on the plurality of buttons.

8. The display method of claim 5, wherein the first image is updated in correspondence with the manipulation result of the buttons.

9. A computer-readable recording medium having embodied thereon a computer program for executing the method of any one of claims 5 through 8.
